(19) United States
(12) Patent Application Publication
(10) Pub. No.: US 2004/0258390 A1
(43) Pub. Date: Dec. 23, 2004

(54) Systems and methods for PVR real time distributed storage, playback, and archival of programs on a network

(76) Inventor: Anthony M. Olson, Dakota Dunes, SD (US)

Correspondence Address: GATEWAY, INC., ATTN: SCOTT CHARLES RICHARDSON, 610 GATEWAY DRIVE, MAIL DROP Y-04, N. SIOUX CITY, SD, 57049, US

(21) Appl. No.: 10/601,050

(22) Filed: Jun. 20, 2003

(51) Int. Cl. H04N 5/781

(52) U.S. Cl. 386/46; 386/125

(57) ABSTRACT

PVR devices are improved with the addition of network connectivity, including, ethernet, HPNA, wireless (e.g., 802.11a, 802.11b, 802.11g), and powerline, and the inclusion of a virtual storage management system (VSM). The VSM allows the user to setup either parts of hard disks in computer systems on the network and/or allows a user to setup specific entire hard disk drive(s) in computers on the network to be used as storage space for programs recorded using the user's PVR. The virtual storage manager is provided with logic capable of dividing up the storage of programs in real time, that is, to store blocks of the program in different hard disk drives physically located at different locations on the network.

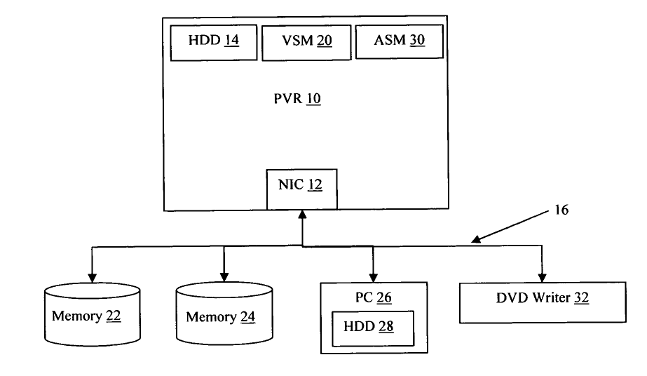

### BACKGROUND OF THE INVENTION

1. Field of the Invention

The present invention relates to devices, systems, and processes useful for storing and distributing data, and more particularly to storage and distribution of programs recorded by a Personal Video Recorder.

2. Brief Description of the Related Art

Personal Video Recorders (PVR) (also known as a Digital Video Recorder, DVR) have become very popular, and with the introduction of relatively low cost PVR devices, have introduced new options for the storage and delayed viewing of video media content —in the context of the present invention, “program” or “programs”. Those of ordinary skill in the art are well aware of the basic components and functionality of a PVR, and therefore PVRs will not be discussed in great depth herein. Typical among the array of features commonly found in a PVR, however, is a memory device (e.g., hard disk drive) having a capacity to store programs up to a certain size, a tuner, optional video encoder and decoder modules (e.g., MPEG decoder and encoders) for analog input and output signals, and an output jack for passing along the signal to another device, usually a television. Executable instructions or logic is typically stored on a portion of the HDD which control the PVR and create a user interface through the television and an input device of the PVR, e.g., a remote control.

While PVRs have proven popular, they have drawbacks that limit their usefulness. The HDD in a PVR is not per se expandable, and adding or replacing a HDD to the PVR introduces issues of compatibility, operating system transfer, as well as other problems. Even the introduction of different levels or grades of data recordation, commonly available on current PVR devices, only somewhat lengthens the total recording capacity of the PVR HDD, and doesn't solve the problem of the PVRs limited recording capacity. While SONICBlue's ReplayTV standalone PVR purports to include an Ethernet card with an RJ-45 jack, serial port, and a USB 1.1 port for wireless connectivity in a wireless home network, it does not address the problem of the storage capacity of the PVR.

An alternative to the PVR, the PC-based video capture card, still fundamentally suffers from the same faults that do current standalone PVRs, including limited recording capacity, because the video capture card stores the programs on the HDD of the PC. While Sony Corp.'s Giga pocket card permits transfer of data to a DVD-R, this option does not expand the system's actual capacity; it merely provides an archival mechanism.

There therefore remains a need for a PVR that has increased storage capacity for programs and increases the ability of the PVR to distribute programs.

### SUMMARY OF THE INVENTION

In a first aspect of the invention, a system useful for storing a television program P comprises a PVR having a first memory, a network interface device, and logic configured to copy the television program P into memory; a second memory in communication with the PVR via the network interface device; virtual storage management (VSM) logic configured to track the location of the second memory on the network, and to store a portion of the program P in the second memory.

In another aspect of the present invention, a system useful for storing a television program P comprises a PVR having a first memory, a network interface device, and means for copying the television program P into memory; a second memory in communication with the PVR via the network interface device; virtual storage management (VSM) means for tracking the location of the second memory on the network, and storing a portion of the program P in the second memory.

In yet another aspect of the present invention, a method of storing a television program P using a PVR having a first memory device comprises identifying a second memory device that is not full on a network in communication with the PVR; and storing at least a portion of the program in the second memory device.

Yet another aspect of the present invention includes a method of playing back a program P using a PVR, the program stored in at least two portions, each portion stored on a separate memory device, each memory device in communication with the PVR, at least one of the memory devices in communication with the PVR via a network, in which the method comprises playing back a first portion through at least the PVR; and playing back a second portion through the network and through the PVR

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which:

The drawing FIGURE schematically illustrates an exemplary system in accordance with the present invention.

### DESCRIPTION OF THE PREFERRED EMBODIMENTS

Referring to the drawing figures, like reference numerals designate identical or corresponding elements throughout the several figures.

In general terms, one aspect of the present invention is the addition of network connectivity to PVR devices. The network connectivity can be any type of network, including, but not limited to, ethernet, HomePNA, wireless (e.g., 802.11a, 802.11b, 802.11g), and powerline. Another aspect of the present invention is the inclusion of a virtual storage management system (VSM), which allows the user to setup either parts of hard disks in computer systems on the network and/or allows a user to setup specific entire hard disk drive(s) in computers on the network to be used as storage space for programs recorded using the user's PVR. The virtual storage manager is provided with logic capable of dividing up the storage of programs in real time, that is, to store blocks of the program in different hard disk drives physically located at different locations on the network.

For example, if one disk (or that portion available to the VSM) is full in the middle of a program, the VSM includes logic that begins storing the remainder of the program on another available hard disk. The VSM includes logic that tracks, in real time, how much storage is available for PVR functionality overall on the network, including which disks are currently active in recording or playback, and which are on-line and off-line. Another aspect of the present invention is that the VSM tracks which parts of a program are stored on which disks, so that playback and storage across separate disks can appear seamless to the user. Because the VSM is capable of informing the user when a computer or disk holding part or all of a program is off-line, the VSM can instruct the user to bring that computer or disk on-line.

Yet another aspect of the present invention is that the VSM includes logic that maintains a real time menu or catalog of available, previously stored programs, as well as control over the typical time delay functionality of PVRs.

Another aspect of the present invention is an archival storage management (ASM) function. Programs that have been recorded can optionally be saved for off-line storage and viewing, such as by writing the program out to writable DVDs, SVCDs, and the like. These archived formats can then be stored either inside the network, such as on a jukebox, or outside of the network and viewed by devices outside of the VSM network such as stand alone DVD players.

Turning now to the drawing FIGURE, an exemplary system in accordance with the present invention is illustrated. As discussed above, PVR 10 includes a Ethernet or network interface device or card (NIC) 12 and a HDD 14, as well as other subcomponents (not illustrated), discussed in part above, which enable the PVR to copy, with optional encoding and decoding, a program or programs onto the HDD. As well understood by those of skill in the art, an operating system (OS) and a set of executable instructions or logic are stored on the HDD, which control the operation of the PVR 10, present information to the user through the television, and permits the user to make selections and input data through the PVR's input controls, e.g., remote control. An optional aspect of the present invention is that the OS can be stored on another memory device with which the PVR 10 is in communication, e.g., such as on another memory device on the network as described in greater detail below. Yet another aspect of the present invention is that the OS can be stored on another type of memory device, e.g., semiconductor, in the PVR, which permits (but does not require) the PVR to be diskless, with data storage on other memory devices as described below.

The NIC 12 is connected to a network 16. The network 16 can be any one of numerous types of networks, including (but not limited to) those described above, and includes both LAN and WAN networks. The PVR includes a VSM 20, preferably implemented as an executable set of instructions or logic stored in the PVR, and more preferably stored on the HDD 14. Logic in the VSM is configured to provide the following functions:

(1) the user, or the VSM automatically, can set up either parts of hard disks in computer systems on the network and/or entire hard disk drive(s) in computers on the network 16 to be used as storage space for programs recorded using the user's PVR.

(2) under user control, or automatically, dividing up the storage of programs in real time, e.g., storing blocks of the program in different hard disk drives physically located at different locations on the network.

(3) tracking, preferably in real time, the total amount of storage on the network that is available for PVR functionality.

(4) tracking, preferably in real time, which disks on the network are currently active in recording or playback.

(5) tracking, preferably in real time, which disks on the network are on-line and off-line.

(6) tracking, preferably in real time, which parts of a program are stored on which disks, so that playback and storage across separate disks can appear seamless to the user.

(7) informing the user when a computer holding part or all of a program is off-line

(8) requesting the user to bring on-line a computer or disk that is off-line.

(9) maintaining a real time menu or catalog of available, previously stored programs, and enabling the user to select one or more of the previously stored programs for viewing.

(10) informing a user before the total available on-line memory runs out.

(11) allowing the user to set a “low water mark”, that is, a lower limit, for the VSM to inform the user prior to running out of memory. By way of a non-limiting example, the lower limit could be set using the amount of storage time left (e.g. ½ of programming) at which the logic will prompt the user for further action.

(12) after informing the user of the ‘low water mark’ condition, further informing the user of the option to erase existing stored files to free up storage in real time to allow the PVR storage to continue.

At least one, and more preferably numerous memory storage devices 22, 24, 28, are also in communication with the VSM 20 and PVR 10 through the NIC 12. The memory devices 22, 24, 28 can each be an entire drive, or each can optionally be a portion of an entire drive. Because the relative cost per gigabyte of memory of HDDs is quite low compared to other storage types, HDDs are preferred as devices 22, 24, 28, although any other type of memory, such as optical, holographic, and semiconductor are also within the scope of the present invention. Further optionally, one or more of these memory devices, such as device 28, can a part of a PC 26 on the network. Alternatively, one or more of the memories 22, 24 can be part of a mass storage drive on the network. As discussed above, by providing access to additional storage via the network 16, the PVR 10, and more particularly the VSM 20, can access the additional memory capacity of these devices, effectively increasing the capacity of the PVR without requiring the user to modify the HDD 14.

As mentioned above, another aspect of the present invention is the optional further inclusion of an Archival Storage Management system (ASM) 30. As with the VSM 20, the ASM 30 is preferably implemented as an executable set of instructions or logic stored in the PVR, and more preferably stored on the HDD 14. For programs that have been recorded, logic in the ASM 30 is configured to permit the user to instruct the ASM to save the program or programs for off-line storage and viewing, such as by writing the program out to writable DVDs, SVCDs, and the like, using a writing device 32. These archived formats can then be stored either inside the network, such as on a jukebox, or outside of the network and viewed by devices outside of the VSM network such as stand alone DVD players. While the drawing figure illustrates the writer 34 being generally available on the network 16, the writer 32 can be a part of a PC, such as PC 26, or can be connected directly to the PVR 10 through an appropriate port (not illustrated).

An example will be instructive. A user instructs the PVR 10 to record a particular program P of interest, using the logic and input devices (e.g., remote control) of the VSM and that which is typically included with a PVR. As the PVR records the program P, the VSM monitors the capacity of HDD 14, as well as additional memory resources available on the network 16. If the VSM determines that none of the memories 22, 24, 28 are available, either because they are full or off-line, the VSM can warn the user that there are no additional memory resources available, and can request the user to bring more memory on-line.

While the program P is still being recorded, the HDD 14 becomes full upon the addition of a portion P1 of the program P. The VSM 20 selects one of the memory resources 22, 24, 28 on the network 16 which is on-line and not full, and begins to store the remainder P2 of the program on the selected memory. In the event that this second memory resource is exhausted, another memory resource on the network is identified, and the VSM stores another portion P3 of the program P to a third memory device. As will be readily appreciated by those of skill in the art, this process of storing, identifying, and storing iterates until either the entire program P is stored, or all of the memory resources are exhausted. The VSM 20 tracks the portions P(i) of the program P and their logical addresses on the network 16 so the VSM can later represent them as the entire program P as if the program P was recorded entirely on the HDD 14.

Once a program P has been recorded, the user can instruct the logic of the PVR 10, including the VSM 20, to play back the program, delete the program, and/or other functions typically included in PVR logic. According to the present invention, the user can optionally select to have a program P copied to archival storage by the ASM 30. Because the ASM 30 operates on a program P that has already been stored in a memory 14, 22, 24, and/or 28, an instruction from the user for the ASM to copy the program P to an archive memory device, such as a DVD-R using the writer 32, does not interfere with the VSM 20. The program P is written to the archival memory, and is further optionally deleted from the memory resource on the network 16.

Another aspect of the present invention is a method of storing media, in particular programs available on a PVR. As discussed in detail above, when the HDD 14 of the PVR is full, either before any part of a program P has been stored on the HDD 14 or after a portion P1 has been stored on the HDD 14, the VSM 20 identifies a second memory resource M2 on the network 16. The VSM 20 then routes a second portion P2 of the program P to the second memory resource M2, until either the program P has been completely recorded, or the second memory resource is full. If the second memory resource M2 is full, a third memory resource M3 is identified on the network 16 and a third portion P3 of the program P is stored in the third memory resource. This process is repeated until the entire program P has been stored, or all of the memory resources M(i) are exhausted. As mentioned above, the user can be requested to bring additional memory resources on-line on the network, and/or to stop storage of the program P.

Yet another aspect of the present invention is a method of playing back a program that has been stored in more than one portion, the portions having been stored on more than one memory device distributed on a network 16. The PVR 10 receives an instruction from the user to play back a program P, which has been previously stored in portions P(i), where i>1, and the portions P(i) are stored on more than one memory resources M(j), where j>1. While i=j in most instances, in general they are separate counters and can have different values, for example if HDD 14 is considered as the first memory resource or not. The VSM 20 looks up the location of memory resource M1 of portion P1, and begins to play back portion P1 until it's end. The VSM 20 then looks up the location of memory resource M(x) and plays back portion P(n), until the portion n=i has been played back.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

What is claimed is:

1. A system useful for storing a television program P, comprising:
a PVR having a first memory, a network interface device, and logic configured to copy the television program P into memory;
a second memory in communication with the PVR via the network interface device;
virtual storage management (VSM) logic configured to track the location of the second memory on the network, and to store a portion of the program P in the second memory.

2. A system in accordance with claim 1, wherein the VSM logic is configured to track the total amount of memory storage on the network that is available for storing at least a portion of a program.

3. A system in accordance with claim 1, wherein the VSM logic is configured to track the memory locations of a plurality of portions P(i) of the program P.

4. A system in accordance with claim 1, wherein the VSM logic is configured to perform at least one of:
(a) track which memory devices on the network are currently active in recording or playback;
(b) track which disks on the network are on-line and off-line;
(c) track the memory locations of previously stored programs;
(d) inform the user when a memory device holding at least a part of a program is off-line;
(e) request the user to bring on-line a memory device that is off-line;
(f) inform a user before the total available on-line memory runs out;
(g) allow the user to set a memory lower limit for the VSM logic to inform the user prior to running out of memory; and
(h) after informing the user of the memory lower limit condition, further provide the user of the option to erase previously stored programs in real time.

5. A system in accordance with claim 1, further comprising:
an archival memory device in communication with the PVR; and
archival storage management (ASM) logic configured to store the program P on the archival memory device.

6. A system in accordance with claim 6, wherein the archival memory device comprises a DVD-R device.

7. A system in accordance with claim 1, wherein the first memory and the second memory each comprise a hard disk drive.

8. A system useful for storing a television program P, comprising:
a PVR having a first memory, a network interface device, and means for copying the television program P into memory;
a second memory in communication with the PVR via the network interface device;
virtual storage management (VSM) means for tracking the location of the second memory on the network, and storing a portion of the program P in the second memory.

9. A system in accordance with claim 8, wherein the VSM means is for tracking the total amount of memory storage on the network that is available for storing at least a portion of a program.

10. A system in accordance with claim 8, wherein the VSM means is for tracking the memory locations of a plurality of portions P(i) of the program P.

11. A system in accordance with claim 8, wherein the VSM means is for at least one of:
(a) tracking which memory devices on the network are currently active in recording or playback;
(b) tracking which disks on the network are on-line and off-line;
(c) tracking the memory locations of previously stored programs;
(d) informing the user when a memory device holding at least a part of a program is off-line; and
(e) requesting the user to bring on-line a memory device that is off-line;
(f) informing a user before the total available on-line memory runs out;
(g) allowing the user to set a memory lower limit for the VSM logic to inform the user prior to running out of memory; and
(h) after informing the user of the memory lower limit condition, further providing the user of the option to erase previously stored programs in real time.

12. A system in accordance with claim 8, further comprising:
an archival memory device in communication with the PVR; and
archival storage management (ASM) means for storing the program P on the archival memory device.

13. A system in accordance with claim 12, wherein the archival memory device comprises a DVD-R device.

14. A system in accordance with claim 8, wherein the first memory and the second memory each comprise a hard disk drive.

15. A method of storing a television program P using a PVR having a first memory device, the method comprising:
identifying a second memory device that is not full on a network in communication with the PVR; and
storing at least a portion of the program in the second memory device.

16. A method in accordance with claim 15, wherein said portion is one of i portions P(i), with i>1, and further comprising:
storing a first portion P1 of the program P in the first memory device.

17. A method in accordance with claim 15, wherein identifying comprises identifying j memory devices that are not full on a network in communication with the PVR, and further comprising sequentially storing a portion of the program P on a memory device of the j memory devices until the entire program has been stored.

18. A method in accordance with claim 15, further comprising:
storing all portions of the program P on an archival memory device.

19. A method of playing back a program P using a PVR, the program stored in at least two portions, each portion stored on a separate memory device, each memory device in communication with the PVR, at least one of the memory devices in communication with the PVR via a network, the method comprising:
playing back a first portion through at least the PVR; and
playing back a second portion through the network and through the PVR.
